(19) United States
(12) Patent Application Publication
(10) Pub. No.: US 2013/0325749 A1
(43) Pub. Date: Dec. 5, 2013

(54) Options in play development hero

(71) Applicants: Thomas Edward Dolezal, Goldsmith, IN (US); Austin Edward Dolezal, Goldsmith, IN (US)

(72) Inventors: Thomas Edward Dolezal, Goldsmith, IN (US); Austin Edward Dolezal, Goldsmith, IN (US)

(73) Assignee: Options in Play Development Hero, Inc.

(21) Appl. No.: 13/506,986

(22) Filed: May 30, 2012

(51) Int. Cl. G06Q 40/06

(52) U.S. Cl. 705/36 R

(57) ABSTRACT

The present invention is in the field of real-estate acquisition for economic development. More particularly, the present invention is drawn to a method for making blocks of real-estate readily available for economic development at a minimum cost to investors, while expediting that development, and rewarding real-estate owners with options to purchase contracts.

### CROSS-REFERENCE TO RELATED APPLICATIONS

Not Applicable

### STATEMENT REGARDING FEDERALLY SPONSORED RESEARCH OR DEVELOPMENT

Not Applicable

### SPECIFICATION

### Background of the Invention

The present invention is in the field of economic development. More particularly, the present invention is drawn to a method for making blocks of real-estate readily available for economic development at a minimum cost to investors, while expediting that development, and rewarding real-estate owners with income from the reassignment of options to purchase contracts as well as successful sale of their property. Options In Play Development Hero benefits from the exposure of the successful sale of properties utilizing the system and the options to purchase reassignment fees.

A real-estate option contract is a contract that allows a purchaser the right to purchase a specific block of real-estate at a fixed price for a certain period of time. The buyer pays a fee for that right (typically 1% to 2% of the purchase price). Currently blocks of real-estate are often set aside for future developments by actually purchasing the real-estate and including it in industrial parks. This requires the outlay of significant amounts of capital to purchase that real-estate to form such parks. Many Local Economic Development Organizations or LEDO's are being formed in communities across the nation to assist in encouraging economic development utilizing this expensive approach. There is no system available to assist these LEDO's in expediting such developments while minimizing the development expense.

### SUMMARY OF THE INVENTION

The Options In Play Development Hero, Inc. Organization or OIPDHO embodies such a system and is illustrated in FIG. 1. It involves using a system of progressively more expensive reassignments of options-to-purchase contracts for real-estate as the duration of the optional right to purchase increases. The OIPDH system can either be contracted for with various LEDO's or can be managed directly by OIPDHO operatives between real-estate owners and investors in an Economic Development Area or EDA not covered by a LEDO. The option-to-purchase contract is a right to purchase not an obligation.

If the OIPDHO is working directly with a real-estate owner without a LEDO involved, a percentage of the options-to-purchase-fees or OPF's goes to the OIPDHO and the remainder goes to the real-estate owner.

If the OIPDHO has contracted with a LEDO, a percentage of the OPF's goes to the OIPDHO, a percentage goes to the LEDO and the remainder goes to the real-estate owner. The LEDO delegates the responsibility for contact with real-estate owners to OIPDHO operatives. A contract between LEDO's and the OIPDHO may be made by signing a Participation Service Agreement or PSA and paying a Participation Service Agreement fee to OIPDHO. A percentage of the OPF's paid to the LEDO is consideration for this contract.

Knowledge of the real-estate available within the economic development zone, LEDO or EDA, its approximate value and a network of potential investors allow the OIPDHO to negotiate options-to-purchase contracts with sellers and arrange meetings between buyers and sellers. LEDO representatives, in cooperation with OIPDHO operatives, determine properties that may be of interest to developers or investors. Subject property owners are contacted and encouraged to access OPIDH web site to learn about the process and the potential OPF's that may be available. LEDO representatives monitor property owners that have registered online at the OIPDH web site or provided an options-to-purchase contract to OIPDHO and contact those that have not responded within a set period of time. Real-estate assets can be earning OPF's while large available tracts of real-estate can be controlled for a minimum investment of OPF's thus expediting economic development.

OIPDHO holds the initial options-to-purchase contracts and reassigns those contracts to a developer or investor for a nominal fee plus the OPF for the desired duration. The advantages of the present invention without limitation will give either a LEDO or potential investors directly an opportunity to minimize the cost and expedite real-estate acquisition for economic development while rewarding real-estate owners with option to purchase contract fees and assistance in selling their property. OIPDHO benefits from the reassignment fees plus the exposure of assisting in real-estate development.

### BRIEF DESCRIPTION OF THE DRAWINGS

The features and other aspects of the invention are explained in the following description along with the accompanying Figures wherein:

FIG. 1 illustrates an exemplary embodiment of a system;

FIG. 2 illustrates the data flow relationships between entities in an exemplary embodiment of a system;

FIG. 3A illustrates the financial flow relationships between parties in an exemplary embodiment of a system where a LEDO is involved;

FIG. 3B illustrates the financial flow relationships between parties in an exemplary embodiment of a system where a LEDO is not involved;

FIG. 4 illustrates steps in a method according to an exemplary embodiment;

FIG. 5 illustrates continued steps in a method according to an exemplary embodiment where a LEDO is involved; and

FIG. 6 illustrates continued steps in a method according to an exemplary embodiment where a LEDO is not involved.

### DETAILED DESCRIPTION OF THE INVENTION

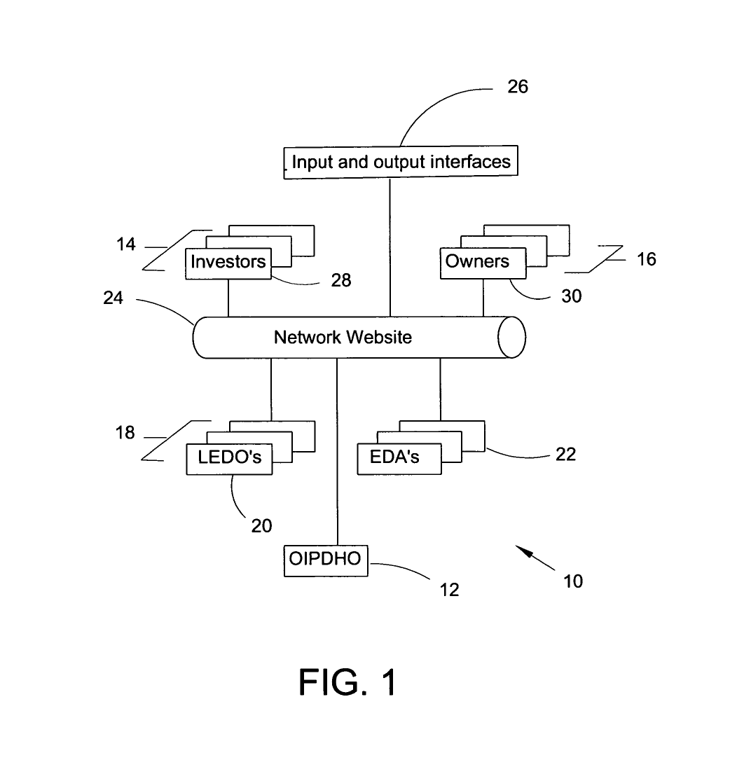

Referring to FIG. 1, an example of Options In Play Development Hero system or OIPDH system 10 includes Options In Play Development Hero, Inc. organization or OIPDHO 12, investors 28, potential investor databases 14, real-estate owners 30, real-estate owner databases 16, Local Economic Development Organization or LEDO 20, network of LEDO's 18, economic development authority or EDA 22 where a LEDO is not involved, electronically interconnected by OIPDH website 24. Data input and output interfaces 26, Option-to-Purchase contracts or OP contracts 32, Participation Service Agreements or PSA's 34, plat maps of EDA covered area 36 or plat maps of LEDO covered area 38 and appraised value maps of EDA area 40 or appraised value map of LEDO covered area 42, involve and interact with various forms of computers and associated peripherals and components. These may be general or special purpose computers, each with one or more central processing units, fixed or removable storage for program code and program data, volatile and non-volatile memory, I/O devices such as keyboards, display screens, printers, pointing devices and network interface devices. Website 24 may exist on one or more of a local area network, a wide area network, the internet or the public switched telephone network.

OP contracts 32 are broken into three time durations t₁, t₂ and t₃. An OP contract 32 term of t₁ equal to approximately 30 days or less requires the consideration of an OPFS 44 for a short term option contract; an OP contract 32 term of t₂ between 30 days and six months requires the consideration of an OPFM 46 for a medium term option contract; and an OP contract 32 term of t₃ of between 6 months and one year requires the consideration of an OPFL 48 for a long term option contract. The duration of the various term lengths are exemplary and different term lengths are negotiable to facilitate specific projects.

OP contracts 32 are progressively more expensive as the duration t increases. An embodiment disclosing a typical set of option to purchase fees or OPF's 50 shows an OPFS 44 set at 0.25% of Sell Price, an OPFM 46 set at 1% of Sell Price, and an OPFL 48 set at 2% of Sell Price. These are exemplary fees and may be adjusted for specific economic development areas 22, LEDO's 20 or the status of the national economy.

PSA's 34 are agreements between LEDO's 20 and OIPDHO 12 wherein LEDO 20 delegates to OIPDHO 12 the responsibility of ascertaining the best match between investors 28 and real-estate owners 30 and negotiating OP contracts 32 between them. OIPDHO 12 is also responsible for collecting the OPF's 50 and disbursing them to LEDO 20, OIPDHO 12 and real-estate owner 30 at the contracted percentages. OIPDHO 12 receives a payment from LEDO 20 in consideration of that PSA 34, typically $10,000.00, but that consideration is subject to negotiation with LEDO 20.

If a LEDO 20 is involved, OPF's 50 are typically distributed 50% to real-estate owner 30, 25% to LEDO 20 and 25% is retained by OIPDHO 12. If LEDO 20 is not involved, the distribution is typically 50% to real-estate owner 30 and 50% to OIPDHO 12.

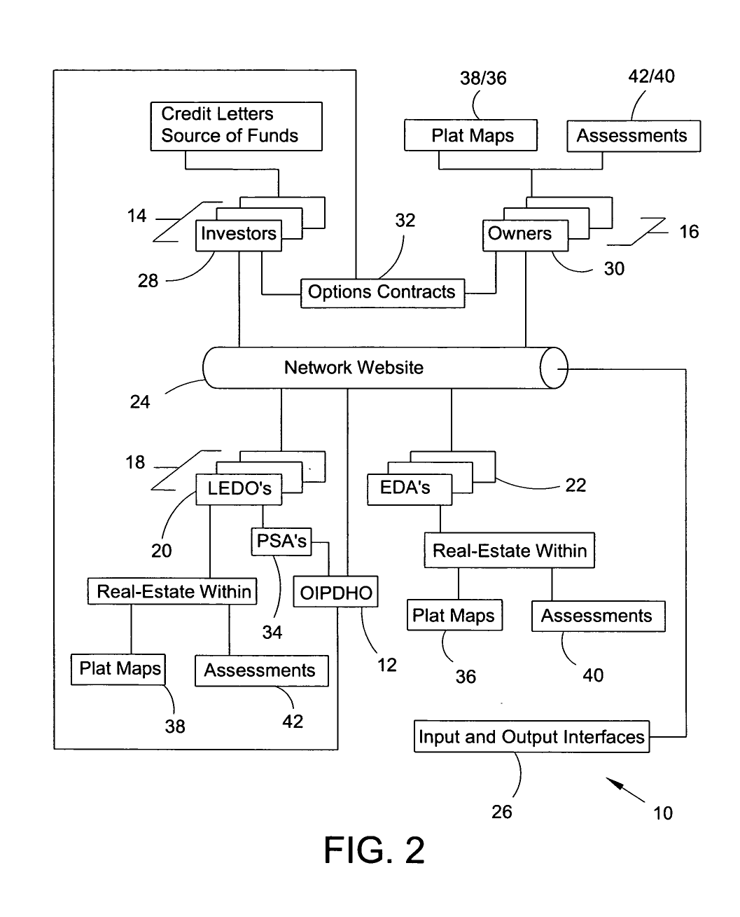

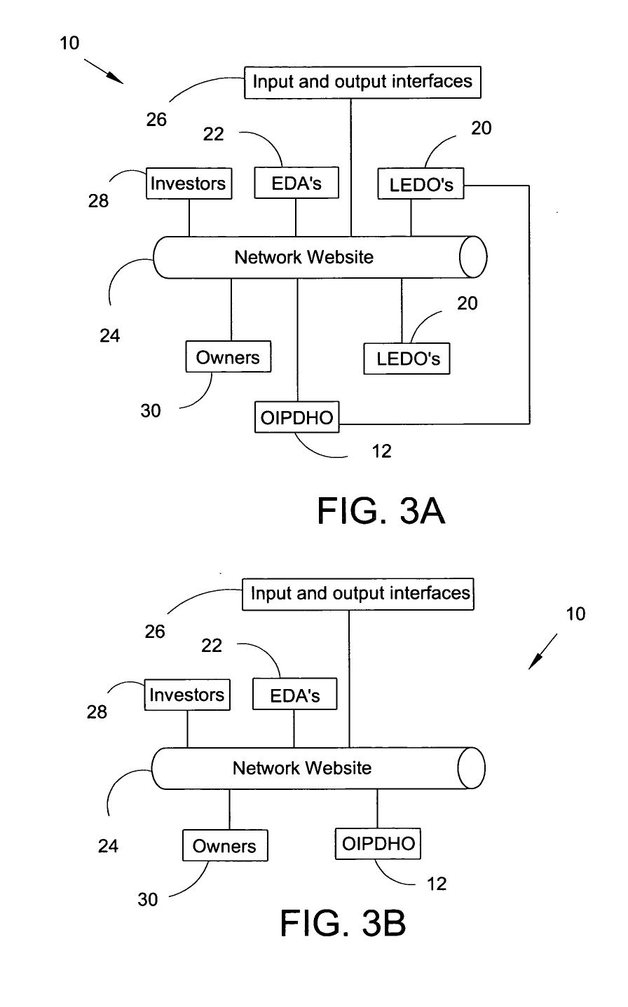

FIG. 1 shows a system flow diagram of OIPDH 10, showing the interactions between the investor data base 14 and the real-estate owner database 16, the OIPDH website 24 and the OIPDHO 12. FIG. 2 shows the data flow from place to place within OIPDH system 10 and FIG. 3 shows the financial flow diagram within OIPDH system 10.

### OPERATION OF INVENTION

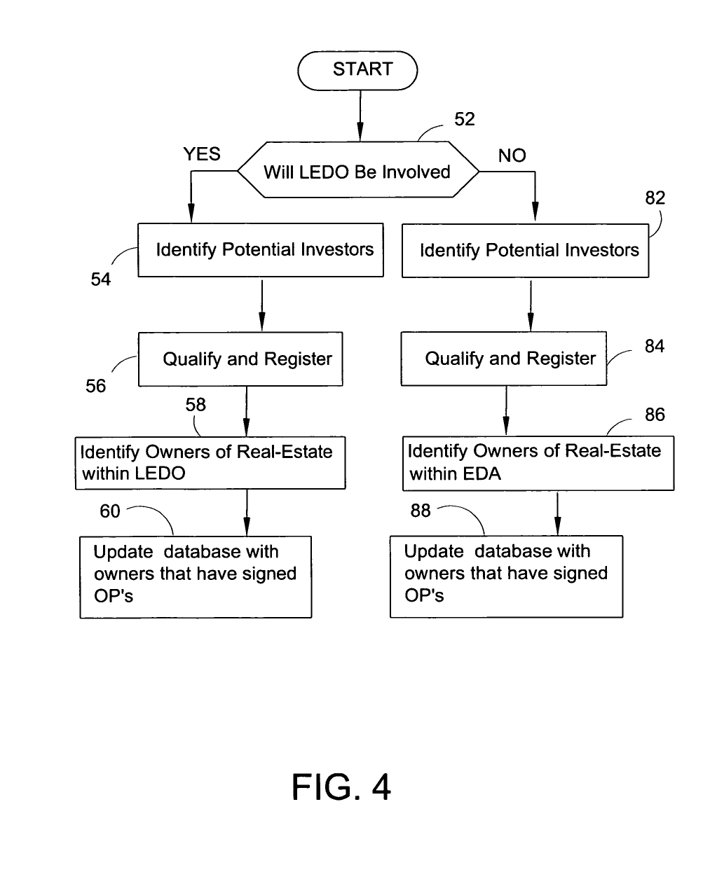

Referring to FIG. 4, in an example embodiment, at step 52, OIPDH system 10 system determines whether a LEDO will be involved in the development process.

At step 54 potential investors 28 are identified.

At step 56 potential investors are prequalified and registered in the potential investor database 14.

At step 58 all real-estate owners 30 within LEDO 18 assessment areas are identified and recorded in Owners database 16 for future solicitation.

At step 60 real-estate owner's database 16 is updated with current owners 30 that have entered into OP contracts 32.

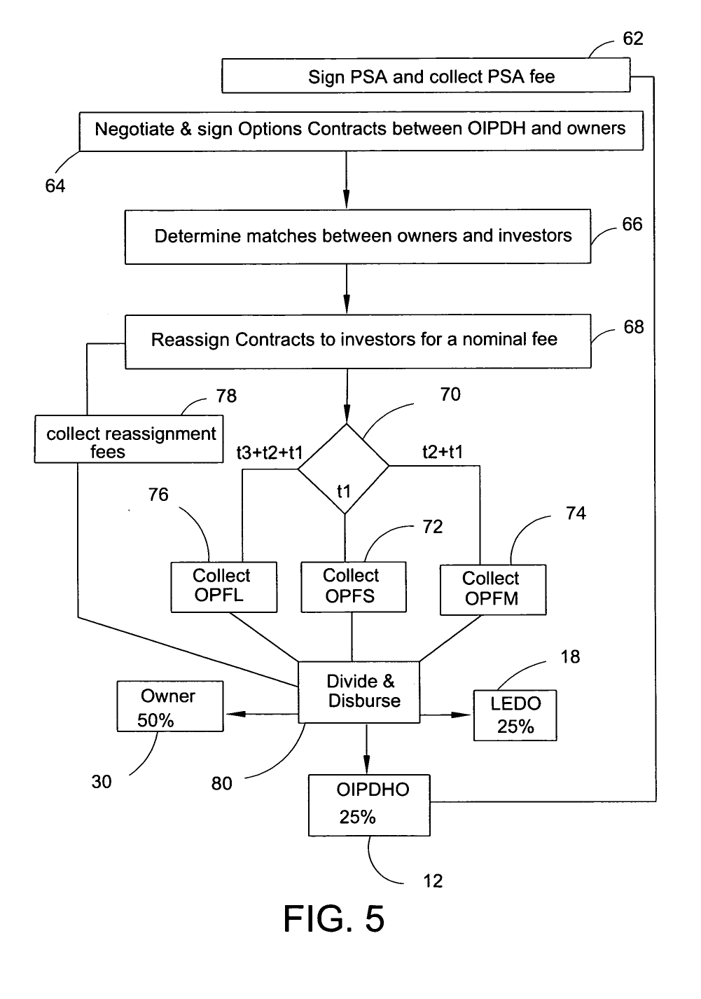

The process continues on sheet 5, FIG. 5 where step 62 shows a Participation Service Agreement or PSA 34 is signed, the PSA fee collected and distributed to OIPDHO 12.

At step 64, LEDO 18 delegates to OIPDH system 10 the responsibility for negotiating options contracts 32 between Owners 30 and investors 28 and the execution of them.

At step 66 matches between owners 30 and investors 28 are determined by OIPDH operatives. Option contracts 32 are held by OIPDHO 12.

At step 68 Options contracts 32 are reassigned to investors 28 for a nominal fee.

At step 70 a determination is made as to if the OP 32 is for the duration t₁, t₁+t₂, or t₁+t₂+t₃.

At step 72 where the short term t₁ duration is selected the short term OPFS 44 is collected and delivered to OIPDHO. In an exemplary embodiment OPFS 44 is 0.25% of sell price.

At step 74 where the medium term t₁+t₂ duration is selected the medium term OPFM 46 is collected and delivered to OIPDH system 10. In an exemplary embodiment OPFM 46 is 1% of sell price.

At step 76 where the long term t₁+t₂+t₃ duration is selected the long term OPFL 48 is collected and delivered to OIPDH system 10. In an exemplary embodiment OPFM 48 is 2% of sell price.

At step 78 reassignment nominal fees are collected and deposited in OIPDH system 10.

At step 80 the OPF's 44, 46 and 48 and the reassignment nominal fees are divided and distributed, again in an exemplary embodiment, 50% to the real-estate owner 30, 25% to LEDO 18 and 25% to OIPDHO 12.

If an Economic Development Authority or EDA 22 other than LEDO 18 is involved that allows OIPDH system 10 to work directly between owners 30 and investors 28 then system 10 loops back to the NO decision on step 52 on FIG. 4.

At step 82 potential investors 28 are identified.

At step 84 potential investors are prequalified and registered in the potential investor database 14.

At step 86 all real-estate owners 30 within EDA 22 assessment areas are identified and recorded in Owners database 16 for future solicitation.

At step 88 real-estate owner's database 16 is updated with current owners 30 that have entered into OP contracts 32.

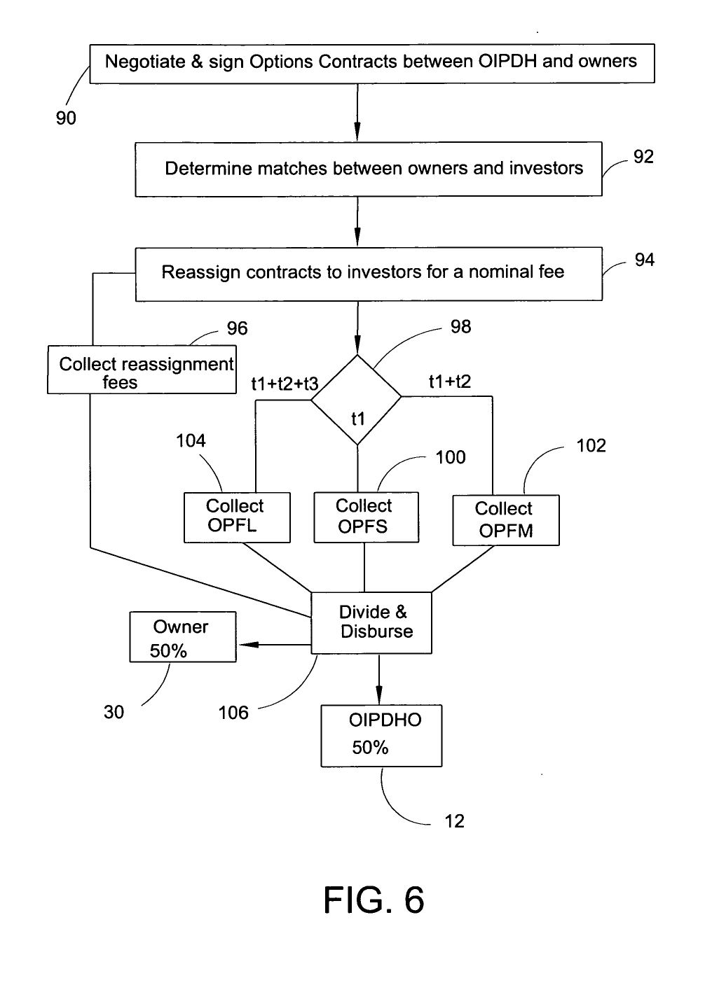

Jumping to FIG. 6 at step 90 option to purchase contracts 32 are negotiated between OIPDH system 10 operatives and owners 30. Option contracts 32 are held by OIPDHO.

At step 92 potential matches between owners 30 and investors 28 are determined by OIPDH system operatives.

At step 94 Options contracts 32 are reassigned to investors 28 for a nominal fee.

At step 96 the nominal fees for the reassignment paperwork are collected and deposited in OIPDH system 10.

At step 98 a determination is made as to if the OP 32 is for the duration t₁, t₁+t₂, or t₁+t₂+t₃.

At step 100 where the short term t₁ duration is selected the short term OPFS 44 is collected and delivered to OIPDHO. In an exemplary embodiment OPFS 44 is 0.25% of sell price.

At step 102 where the medium term t₁+t₂ duration is selected the medium term OPFM 46 is collected and delivered to OIPDH system 10. In an exemplary embodiment OPFM 46 is 1% of sell price.

At step 104 where the long term t₁+t₂+t₃ duration is selected the long term OPFL 48 is collected and delivered to OIPDH system 10. In an exemplary embodiment OPFM 48 is 2% of sell price.

At step 106 the OPF's 44, 46 and 48 and the reassignment nominal fees are divided and distributed, again in an exemplary embodiment, 50% to the real-estate owner 30, 25% to LEDO 18 and 25% to OIPDHO 12.

Utilizing knowledge of investor 28 interests and OP contracts 32 signed, OIPDHO 12 operatives negotiate sale of real-estate while minimizing the upfront outlay of capital by investors or developers 28 and generating an income stream for real-estate owners 30.

FIG. 3 shows OIPDH web site 24 is set up with a means to accept OPF's 50 from investors 28, LEDO's 20 or development authorities 22 and distribute them to real-estate owners 30, LEDO's 20 and OIPDHO 12. If a PSA 34 has been signed its consideration is received and deposited in OIPDHO 12. An embodiment discloses a typical distribution of OPF's 50 of 50% to real-estate owner 30, 25% to LEDO 20, and the remainder retained by OPIDHO 12. If no PSA 34 signed, the distribution is typically 50% for owner 30 and 50% to OIPDHO 12. OPF's 50 are designed to encourage quick reaction by investors 28 by increasing OPF 50 as the duration of the option extends and to fairly compensate real-estate owner 30 for extension of time his property is off the market. An embodiment of an OIPDH system 10 discloses a short, medium and long term option cost. A short term option or OPFS 44 is suggested @0.25% of Sell Price; a medium term option or OPFM 46 is suggested @1% of Sell Price; and a long term option or OPFL 48 is suggested @2% of Sell Price. Suggested term lengths are approximately 30 days or less, an extension of six months and a second extension of another six months or 13 months in total respectively for the short term+medium term+and long term.

While the foregoing written descriptions of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods within the scope and spirit of the invention.

1. A method for minimizing the expense real-estate acquisition for economic development, the method comprising:
identifying potential financial investors in real-estate acquisition;
prequalifying potential financial investors in real-estate acquisition;
registering prequalified investors in investor database;
Identifying owners of real-estate within Local Economic Development Organization or LEDO or economic development authority or EDA;
verifying current ownership records for real-estate within LEDO or EDA of said real-estate from public records;
developing an option to purchase contract based at least in part on the duration or pendency of the option;
meeting with owners of real-estate within LEDO or EDA and convincing them to make their real-estate available for options to purchase contracts;
determining matches between potential investors and real-estate owners;
negotiating options to purchase contracts between investors and owners, the contracts to be held by OIPDH system;
negotiating Participation Service Agreements between LEDO's and Options In Play Development Hero, Inc. or OIPDH system if LEDO involved in development activity and collecting consideration for said agreements;
collecting options to purchase fees or OPF's from investors;
closing contracts and reassigning contracts from OIPDH system to LEDO or investor for nominal fee; and
distributing a percentage of the OPF's to the real-estate owners, a percentage of the OPF's to the LEDO if PSA completed and the remainder of the OPF's to the OIPDH system.

2. A method according to claim 1, wherein the option to purchase is for a short term or OPS, approximately 30 days or less.

3. A method according to claim 1, wherein the option to purchase is for approximately a six month extension to a medium term or OPM, approximately greater than 30 days but less than or equal to six months.

4. A method according to claim 1, wherein the option to purchase is for approximately a second six month extension to a long term or OPL, approximately greater than 7 months but less than or equal to thirteen months.

5. A method according to claim 1, wherein the OPS is approximately 0.25% of sell price for the short term.

6. A method according to claim 1, wherein the OPM is approximately 1% of sell price for the medium term.

7. A method according to claim 1, wherein the OPL is approximately 2% of sell price for the long term.

8. A method according to claim 1, wherein the Option to Purchase Fees are collected by OIPDH system and 50% are distributed to the real-estate owner, 25% to the LEDO if Participation Service Agreement signed and consideration received with the remainder left for OIPDH system.

9. A system for minimizing the expense of real-estate acquisition for economic development comprising:
means for identifying potential financial investors;
means for prequalifying potential financial investors and registering them in an investor database;
means for identifying real-estate owners within LEDO or EDA;
means for developing offer to purchase contracts based, at least in part, on the duration or pendency of the option;
means for offering options to purchase contracts to real-estate owners;
means for offering options to appropriate investors;
means for receiving Participation Service Agreements fees from LEDO's;
means for receiving Options to Purchase Fees or OPF's;
means for distributing OPF's to real-estate owners, LEDO's if PSA signed and consideration received with the remainder to OIPDH system.

10. A computer readable medium having computer executable software code stored thereon, the code for minimizing the expense of real-estate acquisition for economic development, the code comprising:
code to identify and prequalify financial investors;
code to identify at least one real-estate acquisition for economic development;
code to identify real-estate owners within LEDO or EDA;
code to present offers to purchase to real-estate owners;
code to make presentations to investors;
code to receive PSA fees from LEDO's;
code to receive OPF's from investors wherein the OPF's become more expensive as the duration or pendency of the option increases;
code to distribute a percentage to real-estate owners, a percentage to LEDO's if PSA signed and consideration received, with the remainder of OPF's to OIPDH system.

11. A programmed computer for minimizing the expense of real-estate acquisition for economic development, comprising:
a memory having at least one region for storing computer executable program code; and
a processor for executing the program code stored in the memory, wherein the program code comprises:
code to identify and prequalify financial investors;
code to identify at least one real-estate acquisition for economic development;
code to identify real-estate owners within LEDO or EDA;
code to determine assessed value of real-estate within the LEDO or EDA;
code to present offers to purchase to real-estate owners;
code to make presentations to investors;
code to receive PSA fees from LEDO's;
code to receive OPF's from investors wherein the OPF's become more expensive as the duration or pendency of the option increases;
code to distribute a percentage to real-estate owners, a percentage to LEDO's if PSA signed and consideration received, with the remainder of OPF's to OIPDH system.
